(19) United States
(12) Patent Application Publication
(10) Pub. No.: US 2023/0315374 A1
(43) Pub. Date: Oct. 5, 2023

(54) DISTRACTION FILTERING MODE FOR DISPLAYS

(71) Applicant: Lenovo (United States) Inc., Morrisville, NC (US)

(72) Inventors: Mark Delaney, Raleigh, NC (US); Russell Speight VanBlon, Raleigh, NC (US); John C Mese, Cary, NC (US); Arnold Weksler, Raleigh, NC (US); Nathan Peterson, Oxford (US)

(21) Appl. No.: 17/710,407

(22) Filed: Mar. 31, 2022

(51) Int. Cl. G06F 3/14; G06F 3/01; G06T 5/00

(52) U.S. Cl. CPC G06F 3/1423; G06F 3/013; G06T 5/007

(57) ABSTRACT

One embodiment provides a method, the method including: receiving, at a distraction reduction system, input from a user initiating a distraction filtering mode of a computing system; determining, using the distraction reduction system, a focus application from a plurality of applications visible on a display system; and modifying, using the distraction reduction system, settings of the display system, wherein the modifying includes reducing a visibility of a portion of the display system not displaying the focus application.

### BACKGROUND

Since processing systems are used to perform many different functions, users find the need to have more than one application open at a time. Frequently, the users need to have more than one application visible at a single time. For example, the user may update information displayed in one application while referring to information contained in another application, thereby requiring the user to have both applications displayed on the same. Additionally, there are many times where a user may need more than two applications visible at a single time. However, as more applications are opened, more display real estate is used, thereby reducing the size of the applications that are visible. Thus, more and more users are using display systems that provide more display real estate than standard display systems. For example, a user may use multiple display monitors, oversized monitors, and/or the like. This allows the user to have many different applications visible at the same time while allowing them to be of a size that is usable to the user.

### BRIEF SUMMARY

In summary, one aspect provides a method, the method including: receiving, at a distraction reduction system, input from a user initiating a distraction filtering mode of a computing system; identifying, using the distraction reduction system, a focus application from a plurality of applications visible on a display system; and modifying, using the distraction reduction system, settings of the display system, wherein the modifying includes reducing a visibility of a portion of the display system not displaying the focus application.

Another aspect provides an information handling device, the information handling device including: a display system; a processor operatively coupled to the display system; a memory device that stores instructions that, when executed by the processor, causes the information handling device to: receive, at a distraction reduction system, input from a user initiating a distraction filtering mode of a computing system; identify, using the distraction reduction system, a focus application from a plurality of applications visible on the display system; and modify, using the distraction reduction system, settings of the display system, wherein the modifying includes reducing a visibility of a portion of the display system not displaying the focus application.

A further aspect provides a product, the product including: a computer-readable storage device that stores executable code that, when executed by a processor, causes the product to: receive, at a distraction reduction system, input from a user initiating a distraction filtering mode of a computing system; identify, using the distraction reduction system, a focus application from a plurality of applications visible on a display system; and modify, using the distraction reduction system, settings of the display system, wherein the modifying includes reducing a visibility of a portion of the display system not displaying the focus application.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for modifying display system settings responsive to determining that a user has initiated a distraction filtering mode of the display system and identifying a focus application visible on the display system.

FIG. 4 illustrates an example display system with multiple displays or monitors.

FIG. 5 illustrates an example display system with an oversized monitor.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

The problem with having more display real estate is that applications tend to get opened and then not closed or minimized because new applications can be placed in different locations that do not interfere with the previously opened application. Additionally, since the user has more space on the display system, the user may choose to have more applications visible on the display system with some applications being applications that are used throughout the day or accessed frequently. For example, a user may want to have an email application visible on a portion of the display system even though the user is not actively using the email application. However, the problem with having so many applications visible at the same time, is that it is very easy for the user to get distracted from a desired task. For example, if the user is focusing on a different application but sees an email come into the email application, the user may be distracted to look at the email, thereby taking the user away from the desired task.

Conventionally, in order for a user to focus on a particular task without distraction from other applications, the user has to minimize or close the other applications. Additionally, in the event that a distracting application is displayed on a display of a device other than the device having the desired application or set of applications, the user could turn off the distracting device. Conventional solutions have been made to assist in reducing distracting notifications, but not for reducing distracting applications on displays. In conventional solutions, a notification filtering mode, referred to as focus mode, can be engaged. Engagement of focus mode causes notifications that would normally be displayed to be reduced or turned off completely. Some focus modes will determine an importance of the notification and then prevent notifications corresponding to unimportant notifications from being displayed during focus mode. While this reduces some distractions to a user, it only reduces notification distractions and does not reduce distractions caused by visible applications.

Accordingly, the described system and method provides a technique for modifying display system settings responsive to determining that a user has initiated a distraction filtering mode of the display system and identifying a focus application visible on the display system. The distraction reduction system receives input from a user initiating a distraction filtering mode of a computing system. The input may be direct user input where the user specifically engages the distraction filtering mode or may be an inferred input where the system infers that the user wants to engage the distraction filtering mode. Upon engagement of the distraction filtering mode, the system identifies an application, or applications, that is to be the application(s) of focus, referred to as the focus application(s). The application is identified from a plurality of applications that are active or visible on the display system of the user.

Once the focus application(s) is identified, the system can modify settings of the display system that results in the other applications, referred to as distracting applications, being less visible on the display system. In other words, the system can modify settings of the display system that reduces a visibility of a portion of the display system that is not displaying the focus application(s). Depending on the display system set-up (e.g., multiple monitors, multiple devices with monitors, oversized display, a combination thereof, etc.), reducing the visibility of a portion of the display system may be performed using a few different techniques. In the case of multiple monitors, whether directly coupled to a single computing system or monitors of multiple computing systems, the distraction filtering system may reduce the visibility of one or more monitors that are not displaying the focus application(s). In the case of an oversized display, the distraction filtering system may isolate pixels corresponding to the focus application(s) and then reduce the visibility of all remaining pixels. Combinations of the techniques may also be possible.

Therefore, a system provides a technical improvement over traditional methods for displaying applications on display systems. The described system and method provide a type of focus mode for users that modifies display system settings so that the user can be more focused on the target application(s) and less distracted by other applications visible on the display system. Unlike conventional focus mode solutions that only modify notification attributes, the described system modifies display system settings to help reduce distractions to the user. Additionally, the described system is able to work across multiple devices that may each have their own display devices, instead of a single device.

Unlike conventional techniques where a user has to minimize or close other applications to reduce the distraction of these applications, the described system modifies the display settings attributes to make these applications less visible and, therefore, less distracting without requiring the user to minimize or close the distracting applications. Thus, the described system provides a technique for assisting a user in focusing on a task by modifying display settings related to distracting applications in a manner that requires less user input, is more effective, and provides more assistance in reducing distractions than conventional techniques.

The illustrated example embodiments will be best understood by reference to the figures. The following description is intended only by way of example, and simply illustrates certain example embodiments.

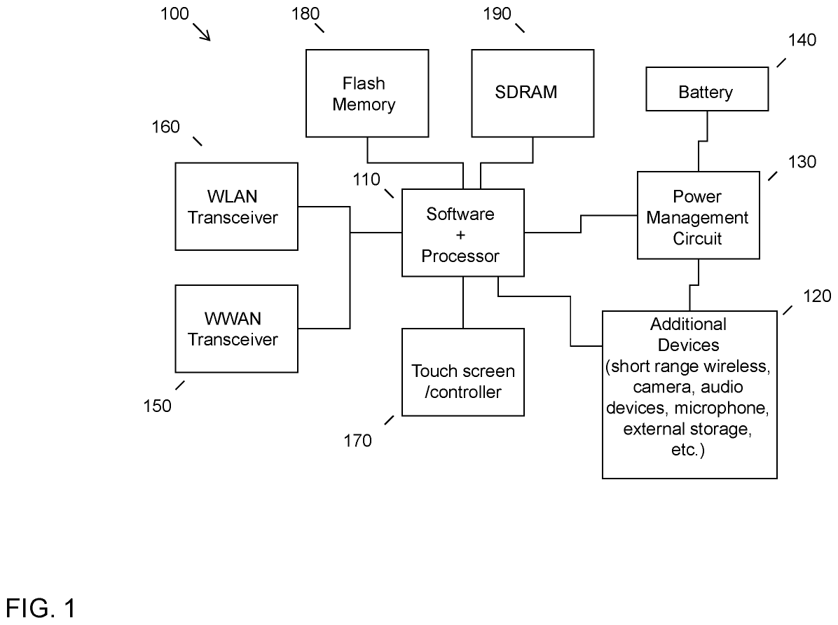

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks, such as telecommunications networks and wireless Internet devices, e.g., access points. Additionally, devices 120 are commonly included, e.g., a wireless communication device, external storage, etc. System 100 often includes a touch screen 170 for data input and display/rendering. System 100 also typically includes various memory devices, for example flash memory 180 and synchronous dynamic random-access memory (SDRAM) 190.

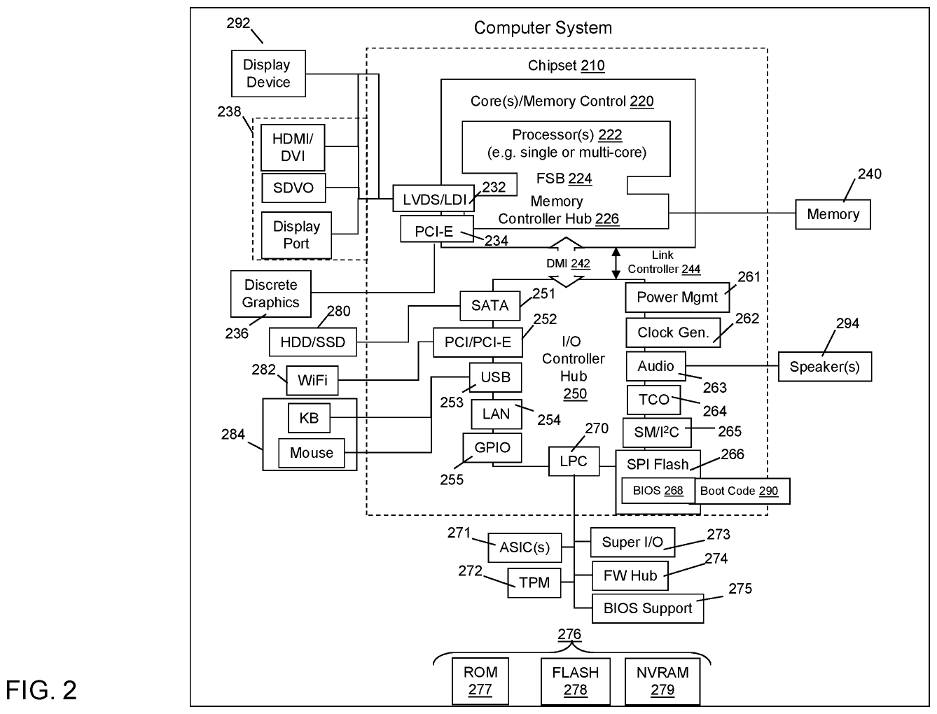

FIG. 2 depicts a block diagram of another example of information handling device circuits, circuitry or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may be used in systems that modify settings of a display system. For example, the circuitry outlined in FIG. 1 may be implemented in a tablet or smart phone embodiment, whereas the circuitry outlined in FIG. 2 may be implemented in a personal computer embodiment.

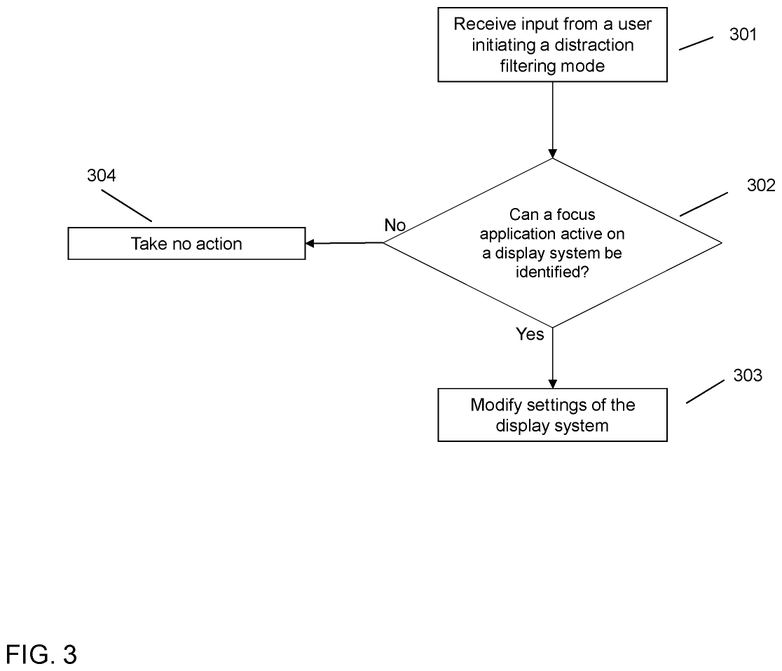

FIG. 3 illustrates an example method for modifying display system settings responsive to determining that a user has initiated a distraction filtering mode of the display system and identifying a focus application visible on the display system. The method may be implemented on a system which includes a processor, memory device, output devices (e.g., display device, printer, etc.), input devices (e.g., keyboard, touch screen, mouse, microphones, sensors, biometric scanners, etc.), image capture devices, and/or other components, for example, those discussed in connection with FIG. 1 and/or FIG. 2. While the system may include known hardware and software components and/or hardware and software components developed in the future, the system itself is specifically programmed to perform the functions as described herein to modify settings of display systems in a distraction filtering mode. Additionally, the distraction reduction system includes modules and features that are unique to the described system.

The described system may be applied to cases where the user has multiple monitors coupled to a single computing system, multiple computing system each having one or more monitors, an oversized display, a combination thereof, or any other display system configuration. Thus, the term display system refers to any of these types of display configurations. For ease of readability, the application(s) the user is attempting to focus on will be referred to as the focus application. However, it should be understood that multiple applications may be used in a single task. Thus, the system may identify more than one focus application. In this case, the term focus application would cover all applications that are needed by the user to perform the desired task. Additionally, the application(s) that a user is not focusing on or that are not identified as a focus application will be referred to as distracting applications. The distracting applications may include a single application or may include multiple applications.

Additionally, in the case that the user has multiple monitors or displays, either for a single device or across multiple devices, the distracting applications can be found on one, more than one, or all monitors or displays. Thus, even the non-oversized display configuration, some of the techniques described in connection with the oversized display configuration could be applied. For example, if a single non-oversized display has both a focus application and a distracting application, the system could apply the pixel isolating technique or any other technique described herein to reduce a visibility of part of the non-oversized display corresponding to the distracting application while allowing the focus application to remain visible.

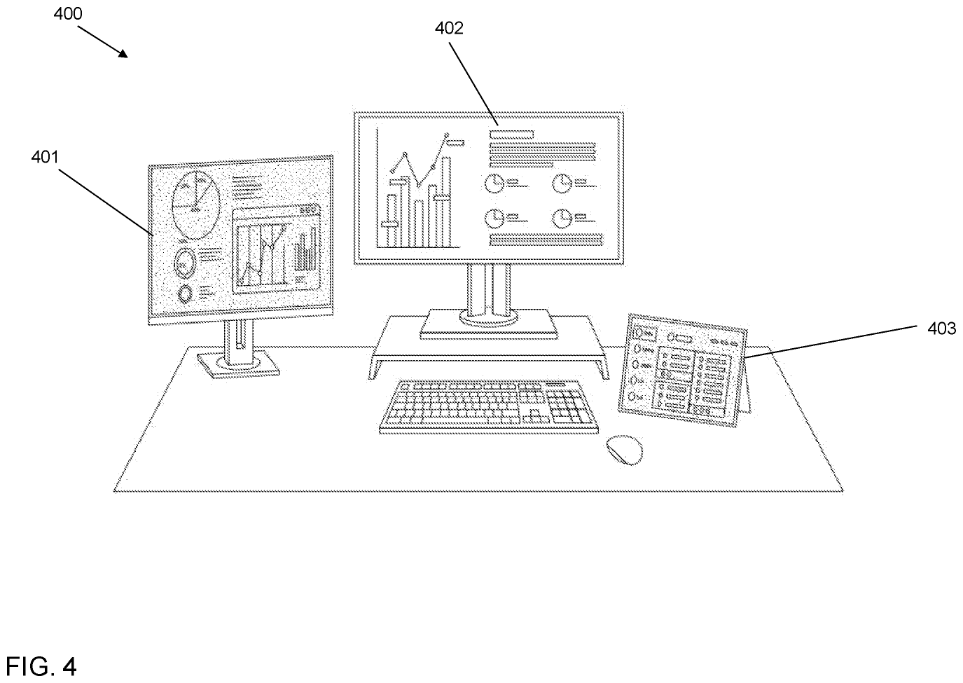

At 301, the distraction reduction system receives input from a user initiating a distraction filtering mode of a computing system. The computing system may include a processing portion and a display system, for example, a laptop, tablet, smart phone, smart television, personal computer, and/or the like. Additionally, the computing system may include separate processing portions and display systems where the displays are operatively coupled to the processing portion, for example, a client device connected to a display device, a device not having an integral display connected to a display device, and/or the like. The computing system may also multiple devices, each having a monitor or display connected together either directly or indirect, for example, through a network, through a router, through a hub device, and/or the like. FIG. 4 illustrates an example, computing system having multiple devices interconnected 400. The computing system of FIG. 4 illustrates a dual monitor 402, a stand-alone monitor 401, and a tablet having a display 403. These devices are all in operative communication with one another or a device that is in communication with all the devices and/or displays. Thus, the display system can include displays of a plurality of devices within proximity to the user.

The distraction filtering mode is a mode of the computing system that reduces the distractions from distracting applications in the form of modifying settings of the display device to make the distracting applications less visible. The idea would be similar to a focus mode that reduces distractions from notifications, but is instead applied to display settings rather than notifications. It should be noted, however, that the system can employ a conventional focus mode that focuses on notifications in addition to the distraction reduction system described herein the focuses on display settings. A user may want to engage the distraction filtering mode when the user is attempting to focus on a particular task and, therefore, an application or applications corresponding to that task.

The input from the user to initiate a distraction filtering mode may include direct user input or indirect or inferred user input. Direct user input is input provided by the user directly to the computing system where the distraction filtering mode is to be engaged. The direct user input may include, but is not limited to, the user providing selection input to engage the distraction filtering mode at an icon, switch, pop-up window, and/or the like. The selection input may be provided using a mechanical input device, for example, keyboard, mouse, touch input, and/or the like. Direct user input may also include, but is not limited to, the user providing audio, gesture, and/or other non-mechanical input, to engage the distraction filtering mode. For example, the system may include a digital assistant that responds to voice commands and the user can provide a voice command to the digital assistant to engage the distraction filtering mode.

Indirect or inferred user input is input provided by the user that is used by the computing system to infer that the user wants to engage the distraction filtering mode. In other words, the indirect or inferred user input is input provided by the user that is not specifically for engaging the distraction filtering mode, but rather is used by the system to infer that the distraction filtering mode should be engaged. One example of inferred user input can be identified from user gaze information. The distraction reduction system may monitor the gaze of the user to identify where on the display system the user is looking. If the user looks at an application or applications that are related for a predetermined period of time, the system may infer the user is attempting to focus on the task corresponding to the application(s) and may thereafter engage the distraction filtering mode. The predetermined period of time may be set by the user, a default value, different for different applications, different for different displays of a display system, and/or the like.

Another technique for inferring user input is based upon a context of the user. A context of the user identifies whether a relationship exists between what a user is currently doing and what the user will be doing in the near future. The context of the user may be identified based upon different secondary inputs or information of the user. Secondary inputs or information may correspond to other applications (e.g., calendar applications, meeting applications, communication applications, etc.), a location of the user (e.g., work, home, home office, meeting room, etc.), communications of the user (e.g., emails, text messages, instant messages, group messages, etc.), and/or the like.

Any of these secondary input or information can provide the system with a context of the user to identify what the user is currently doing and if the user will be doing something related in the near future. For example, if the user is currently looking at a presentation and a secondary information source identifies the user has a meeting in fifteen minutes, the system can infer a context of the user. The inferred context would be that the user is reviewing a presentation for the upcoming meeting. As another example, if the user is currently engaging in an instant message exchange with a colleague and discussing a project that needs to be finished within a set time, this secondary information source indicates that when the user starts looking at applications related to the project, the user needs to perform this task within the set time. Thus, the context is inferred by the system. In both of these examples, the system would infer that the user wants the distraction filtering mode engaged.

A final example technique for inferring user input is based upon an intent of the user. The intent of the user identifies what the user wants to be doing or focusing on. Thus, the intent can be used to identify if the user wants to focus on an application(s) and, if so, that the distraction filtering mode should be engaged. In other words, the intent attempts to identify if the user is trying or wanting to focus on a task and corresponding application(s), even if the user is not being successful at focusing on the application(s). Intents can be identified from historical information of a user. The historical information may be used to glean correlations between what a user is doing and what the user is trying to do. In gleaning the correlations, the system may also use the context information to make more accurate correlations.

To identify an intent of the user, the system may employ one or more machine-learning models that are trained on intents and corresponding distraction filtering actions, for example, as identified from the historical information of the user, as identified from the historical context information of the user, and/or the like. As the machine-learning model makes predictions and takes actions, new information regarding intents and/or contexts and distraction filtering actions will be identified. This new information can be automatically ingested by the machine-learning model to make better predictions and a more accurate model for intents and/or contexts and corresponding distraction filtering actions.

It should be understood that other techniques for identifying indirect or inferred user input are possible and contemplated and the described techniques are provided as examples. Additionally, indirect or inferred user input may be based upon a combination of factors or techniques. Additionally, or alternatively, a combination of factors may be used to weight a confidence of the system that a distraction filtering mode should be engaged. For example, more factors indicating a user is attempting to focus may make the system more confident that the distraction filtering mode should be engaged. If the confidence increases to meet or exceed a predetermined confidence value, the system may then engage the distraction filtering mode.

In the case that indirect or inferred user input is detected by the system to engage the distraction filtering mode, the system may request the user confirm that the distraction filtering mode should be engaged. Alternatively, the system may simply engage the distraction filtering mode without requesting user confirmation. Whether the system requests user confirmation may be set by the user as a user preference, be based upon historical selections by the user, may be unique to different applications, and/or the like. Thus, the distraction filtering mode and whether it is engaged automatically can be configured by the user. Additionally, or alternatively, if the system determines a confidence value, if the system requests user confirmation may be based upon the confidence value. For example, high confidence values or values exceeding a predetermined threshold may not result in the system requesting confirmation, whereas low confidence values or confidence values less than the predetermined threshold would result in the system requesting confirmation.

At 302, the distraction reduction system determines if a focus application from a plurality of applications visible on the display system can be identified. In other words, the distraction reduction system identifies a focus application (or applications) from the applications visible on the display system. The system may also identify applications as a focus application even though the application may not yet be visible on the display system. For example, if a user is focused on a task and needs another application visible for the task, the system may identify that new application as a focus application. Similarly, the system can identify a newly opened application as a distracting application. Identifying either currently visible or future applications as either focus applications or distracting applications can be performed using the same techniques. In the case of a future application, the focus or distracting application analysis can occur when the application is opened or shortly thereafter. In the case of already visible applications, the focus or distracting application analysis can occur when the distraction filtering mode is engaged.

To identify the focus application, the distraction reduction system may use one or more techniques, or a combination thereof. A simple technique for identifying a focus application is utilizing the gaze of the user. As discussed above, the gaze of the user could be used as input to determine if the distraction filtering mode should be engaged, for example, by determining the user is looking at an application or set of applications for a predetermined length of time. This same technique can be used to identify the focus application. Specifically, the system can identify what application(s) the user is looking at for the predetermined length of time. That application(s) can then be identified as the focus application(s). In the case that the user is looking at more than one application during a predetermined time period, the system may make a determination regarding whether the applications are related or correlated to the focus task.

One technique for determining a focus application is based upon direct user input identifying the focus application(s). The user may also provide input identifying a focus task, which can then be used to identify focus applications. Additionally, or alternatively, to identify the focus application, the system may make correlations between a focus task of the user and applications needed to perform the focus task. Thus, to make the determination regarding what applications may be a focus application, the system may first determine a focus task of the user. The focus task may be determined using the context of the user, intent of the user, a focus of the user, and/or the like. Accordingly, any techniques previously discussed to determine if a distraction filtering mode should be engaged, can also be applied to identify a focus task and/or focus application of a user.

For example, in addition to using the context of the user to infer the user wants to engage the distraction filtering mode, as discussed in connection with 301, the distraction filtering system can also use the context of the user to determine or infer which application(s) should be the focus application(s). Since the context identifies whether a relationship exists between what a user is currently doing and what the user will be doing in the near future, the system can determine what application(s) would or could be used for performing the future task. In other words, the context of the user identifies a task of focus for the user and can, therefore, be used to identify applications that correspond to the task. For example, if a secondary source indicates that a user has a meeting in fifteen minutes, the system may identify reviewing a presentation as a focus task. Thus, the application(s) associated with the presentation would be identified as focus application, for example, the presentation application, a note-taking application, and a correspondence application that identifies comments from other users on the presentation. Like the context, the intent of the user can also be used not only in identifying if the distraction filtering mode should be engaged, but also identifying a focus task and/or application.

In the case that a focus task is identified before a focus application, the system may use the focus task to identify the focus application(s). As stated before, the system can make correlations between the focus task and the focus application(s). The correlations may be stored in a database that the system can access. Once the database or other data storage location is accessed, the system can search for the identified focus task and identify the focus applications that correspond to the focus task. Additionally, or alternatively, these correlations may be made using historical information, a machine-learning model, a learning algorithm, and/or the like. The machine-learning model for identifying task and application correlations can be trained in a similar manner to the intent model. However, instead of intents and/or contexts and distraction filtering actions, the correlation model will be trained using tasks and application correlations, will make predictions regarding applications based upon tasks, and use feedback to make a more accurate correlations model.

If the distraction reduction system cannot identify a focus application at 302, the system may take no action at 304. This may occur if the system determines that the distraction filtering mode should not be engaged, if the system is unable to identify a focus application, if the user overrides the distraction filtering mode, and/or the like.

On the other hand, if the distraction reduction system can identify a focus application(s) at 302, the distraction reduction system may modify settings of the display system to reduce a visibility of a portion of the display system not displaying the focus application(s). In other words, the distraction reduction system modifies the display settings so that distracting applications are less visible than the focus application(s). Thus, the portion of the display system corresponds to the portion of the display system that where the distracting applications are visible. It should be noted that the term visible may include the actual visibility of the portion and also includes a viewability and readability of the portion. In other words, the system may hide the portion so that it is no longer viewable or may simply modify the settings, thereby making the portion less viewable or less readable which will reduce the distraction caused by the application.

Modifying the display settings may include reducing a brightness of the portion of the display system, modifying a saturation of the portion of the display system, adding an obscuring graphic to the portion of the display system, adding a virtual film to the portion of the display system, and/or the like. Since the system is attempting to make the distracting applications less visible, the action taken may modify the display settings such that the portion is less visible. For example, in changing the saturation, the system may oversaturate or under-saturate the portion so that it is not visible or not readable.

The portion of the display system that is modified, and therefore, an action taken to make the portion less visible may be dependent on the display system. In a display system that has a plurality of displays and the plurality of applications are visible across the plurality of displays, the portion may include one or more displays that do not display a focus application. Therefore, the system may be able to turn off the displays that do not have focus applications. On the other hand, if a display has both distracting and focus applications, the system would have to isolate the focus application and then modify the portion of the display not displaying the focus application, but could not turn off the entire display. As another example, if the display system includes an oversized display, the portion of the display may correspond to pixels of the display displaying the distracting applications. Thus, the system may isolate the pixels corresponding to the focus application and then modify the pixels not corresponding to the focus application, for example, by turning off the pixels, changing a brightness of the pixels, and/or the like.

In addition to modifying the display settings, the system may take other actions to assist in reducing distractions to the user caused by applications. For example, the system may reduce or prevent access to applications other than the focus application. In other words, the system may reduce or prevent access to distracting applications while the distraction filtering mode is engaged and active. Other actions may also be taken, for example, shutting down communication applications, activating a Do-Not-Disturb mode for applications having such a feature, moving applications that are all identified as focus application closer together on the display system, and/or the like. It should be understood that there are merely example actions that can be taken as other actions are possible and contemplated.

Once the system determines that the user no longer wants the distraction filtering mode engaged, either by inference or direct user input, the system may automatically reset the settings of the display system. In other words, the system may automatically reset the settings of the display system upon determining the user no longer is utilizing the distraction filtering mode. Inferring that a user is no longer utilizing the distraction filtering mode may be performed in a similar fashion as inferring the user wants to engage the distraction filtering mode.

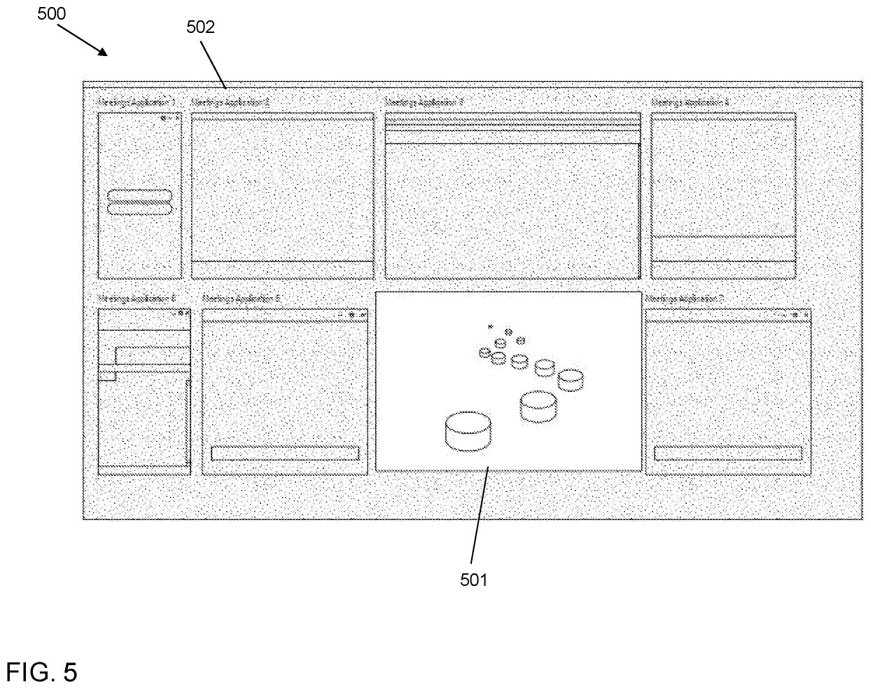

FIG. 4 and FIG. 5 illustrate two example display systems where a distraction filtering mode has been engaged. FIG. 4 illustrates an example display system having a plurality of displays 400. This example display system includes a dual monitor 402, single stand-alone monitor 401, and tablet device having a display 403. In this illustrated example, the dual monitor 402 has the focus application so the single stand-alone monitor 401 and tablet display 403 display settings have been modified to dim the displays 401 and 403. The dual monitor 402 display settings have not been modified.

FIG. 5 illustrates an example display system having an oversized display 500. The focus application is located at 501. The remaining portions of the display device 502 are the distracting applications. Thus, the pixels corresponding to the focus application 501 have been isolated, and the system has modified the display system settings for the remaining pixels 502. As can be seen in FIG. 5, the system also modifies pixels corresponding to the background application, specifically the desktop in this illustrated example. Since the background is visible, the system can identify it as a distracting application also.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A method, the method comprising:
receiving, at a distraction reduction system, input from a user initiating a distraction filtering mode of a computing system;
identifying, using the distraction reduction system, a focus application from a plurality of applications visible on a display system; and
modifying, using the distraction reduction system, settings of the display system, wherein the modifying comprises reducing a visibility of a portion of the display system not displaying the focus application, wherein the modifying the settings of the display system comprises isolating pixels on the display system corresponding to the focus application from pixels of the portion of the display system not displaying the focus application and performing at least one action selected from the group consisting of: reducing a brightness of the portion of the display system, modifying a saturation of the portion of the display system, adding an obscuring graphic to the portion of the display system, and adding a virtual film to the portion of the display system at the pixels of the portion of the display not displaying the focus application.

2. The method of claim 1, wherein the display system comprises a plurality of displays;
wherein the plurality of applications is visible across the plurality of displays; and
wherein the portion of the display system comprises a display of the plurality of displays not displaying the focus application.

3. The method of claim 1, wherein the display system comprises an oversized display.

4. The method of claim 1, wherein the identifying a focus application comprises identifying a context of the user by accessing a secondary information source of the user.

5. The method of claim 1, wherein the receiving input comprises identifying, using gaze information of the user, the user has focused on an application of the plurality of applications for a predetermined length of time and wherein the focus application comprises the application.

6. The method of claim 1, comprising reducing access to applications of the plurality of applications other than the focus application.

7. The method of claim 1, wherein the receiving input comprises identifying, using a machine-learning model, an intent of the user.

8. The method of claim 1, comprising automatically resetting the settings of the display system upon determining the user no longer is utilizing the distraction filtering mode.

9. The method of claim 1, wherein the display system comprises displays of a plurality of devices within proximity to the user.

10. (canceled)

11. An information handling device, the information handling device comprising:
a display system;
a processor operatively coupled to the display system;
a memory device that stores instructions that, when executed by the processor, causes the information handling device to:
receive, at a distraction reduction system, input from a user initiating a distraction filtering mode of a computing system;
identify, using the distraction reduction system, a focus application from a plurality of applications visible on the display system; and
modify, using the distraction reduction system, settings of the display system, wherein the modifying comprises reducing a visibility of a portion of the display system not displaying the focus application, wherein the modifying the settings of the display system comprises isolating pixels on the display system corresponding to the focus application from pixels of the portion of the display system not displaying the focus application and performing at least one action selected from the group consisting of:
reducing a brightness of the portion of the display system, modifying a saturation of the portion of the display system, adding an obscuring graphic to the portion of the display system, and adding a virtual film to the portion of the display system at the pixels of the portion of the display not displaying the focus application.

12. The information handling device of claim 11, wherein the display system comprises a plurality of displays;
wherein the plurality of applications is visible across the plurality of displays; and
wherein the portion of the display system comprises a display of the plurality of displays not displaying the focus application.

13. The information handling device of claim 11, wherein the display system comprises an oversized display.

14. The information handling device of claim 11, wherein the identifying a focus application comprises identifying a context of the user by accessing a secondary information source of the user.

15. The information handling device of claim 11, wherein the receiving input comprises identifying, using gaze information of the user, the user has focused on an application of the plurality of applications for a predetermined length of time and wherein the focus application comprises the application.

16. The information handling device of claim 11, comprising reducing access to applications of the plurality of applications other than the focus application.

17. The information handling device of claim 11, wherein the receiving input comprises identifying, using a machine-learning model, an intent of the user.

18. The information handling device of claim 11, comprising automatically resetting the settings of the display system upon determining the user no longer is utilizing the distraction filtering mode.

19. The information handling device of claim 11, wherein the display system comprises displays of a plurality of devices within proximity to the user.

20. A product, the product comprising:
a computer-readable storage device that stores executable code that, when executed by a processor, causes the product to:
receive, at a distraction reduction system, input from a user initiating a distraction filtering mode of a computing system;
identify, using the distraction reduction system, a focus application from a plurality of applications visible on a display system; and
modify, using the distraction reduction system, settings of the display system, wherein the modifying comprises reducing a visibility of a portion of the display system not displaying the focus application, wherein the modifying the settings of the display system comprises isolating pixels on the display system corresponding to the focus application from pixels of the portion of the display system not displaying the focus application and performing at least one action selected from the group consisting of: reducing a brightness of the portion of the display system, modifying a saturation of the portion of the display system, adding an obscuring graphic to the portion of the display system, and adding a virtual film to the portion of the display system at the pixels of the portion of the display not displaying the focus application.
